(19) United States
(12) Patent Application Publication
(10) Pub. No.: US 2025/0103792 A1
(43) Pub. Date: Mar. 27, 2025

(54) DOCUMENT SOURCE DETECTION USING BIGRAM SPACING

(71) Applicant: EchoMark, Inc., Kirkland, WA (US)

(72) Inventors: Sanjay KRISHNAN, Hinsdale, IL (US); David WONG, Los Gatos, CA (US); Chad VOSS, Seattle, WA (US); Troy BATTERBERRY, Kirkland, WA (US)

(21) Appl. No.: 18/430,439

(22) Filed: Feb. 1, 2024

Related U.S. Application Data
(60) Provisional application No. 63/585,529, filed on Sep. 26, 2023.

(51) Int. Cl. G06F 40/131; G06F 40/274

(52) U.S. Cl. CPC G06F 40/131; G06F 40/274

(57) ABSTRACT

Unique copies of an original document are generated by replacing spatial elements between bigrams with space characters of a uniform character code. An artifact is a derivation of a unique copy. To determine the unique copy from which the artifact was derived, bigrams of the artifact are determined. Spatial elements separating written units of the bigrams are determined to correspond with uniform character code characters, and their respective character identifiers are identified and associated with the bigrams. In some aspects, the spatial elements of the artifact are assigned binary spacing indicators that indicate their relative widths. In either or both events, a correlation can be determined between the character identifiers or the binary spacing indicators of the artifact and the character identifiers of the unique copies for respective bigrams. The unique copy having the strongest correlation is identified as being the unique copy from which the artifact was derived.

### CROSS REFERENCE TO RELATED APPLICATIONS

This Application claims the benefit of priority to U.S. Provisional Application No. 63/585,529, filed Sep. 26, 2023, and entitled “Document Source Detection Using Bigram Spacing,” the contents of which are hereby incorporated by reference in their entirety.

### BACKGROUND

Companies frequently use various mediums to exchange sensitive information, with email being one of the most common methods. Emails often contain critical data such as trade secrets, financial figures, strategic plans, and so forth. The information is usually shared through secure, encrypted email systems to protect the confidentiality of the content. However, even with these protections, unauthorized leaks of such sensitive information from emails, or other documents, can result in significant reputational damage to a company and may also have legal implications.

### SUMMARY

At a high level, the technology described herein relates to spacing techniques to uniquely watermark documents and detect document sources from the unique watermarks. To encode an original document with a unique watermark, thereby generating a unique copy of the original document, bigrams are identified within the original document. Each bigram includes a pair of written units that is separated by a spatial element. The spatial elements of the bigrams can be replaced with space characters from a uniform character code, such as Unicode. The characters include space characters that have slightly different widths. Each unique copy has a different combination of bigram-character pairs forming a bigram code. The bigrams can be stored in a unique copy index and associated with character identifiers corresponding to the characters of the bigram-character pairs. Thus, while each unique copy appears visually similar, a computer can still detect the space differences or the different characters used, thereby identifying differences that distinguish the unique copies. The unique copies can be distributed to various recipients, where each recipient receives a different unique copy.

These differences can be used to identify a unique copy from an artifact. An artifact is a reproduction of a unique copy, in whole or in part. By identifying the unique copy from which the artifact was derived, the initial recipient can be identified. To determine the unique copy from which the artifact was derived, a detector can identify the spatial elements between bigrams within an artifact. Some reproduction methods retain character information in metadata where the spatial elements are characters from a uniform character code. In other cases, the distances between the bigrams in the artifact are measured. A binary spacing indicator can be used to indicate whether a space within a bigram has a width that is greater than or less than the mean width of the spaces. The character information or the binary spacing indicators, depending on the detection technique, are indexed in an artifact index in association with their respective bigrams. These are then compared to the unique copy indexes by correlating the character identifiers or the binary spacing indicators with the known character identifiers of the unique copies. The unique copy, having the highest statistically significant correlation, is the most likely candidate from which the artifact was derived, thus identifying the unique copy, thereby also identifying the recipient. This identification can provide an initial source for a leak investigation, should someone leak sensitive information.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates examples of unique copies that may be generated from an original document using components of FIG. 1, and example artifacts derived therefrom, in accordance with an aspect described herein;

FIG. 3 illustrates an example bigram identification performed by components of FIG. 1, in accordance with an aspect described herein;

FIG. 4 illustrates example unique copies that can be generated using components of FIG. 1, in accordance with an aspect described herein;

FIG. 5 illustrates an example unique copy index(es) generated using components of FIG. 1, in accordance with an aspect described herein;

FIG. 6 illustrates an example artifact derived from a unique copy during a leak event, in accordance with an aspect described herein;

FIG. 7 illustrates another example bigram identification performed by components of FIG. 1, in accordance with an aspect described herein;

FIG. 8 illustrates an example spatial element determination using components of FIG. 1, in accordance with an aspect described herein;

FIG. 9 illustrates another example spatial element determination using components of FIG. 1, in accordance with an aspect described herein;

FIG. 10 illustrates an example artifact index generated using components of FIG. 1, in accordance with an aspect described herein;

FIG. 11 illustrates an example identification of a unique copy from which the example artifact was derived using components of FIG. 1, in accordance with an aspect described herein;

FIG. 12 illustrates an example method 1200 for generating unique copies, in accordance with an aspect described herein;

FIG. 13 illustrates an example method for determining that an artifact was derived from a unique copy using components of FIG. 1, in accordance with an aspect described herein;

FIG. 14 illustrates another example method for determining that an artifact was derived from a unique copy using components of FIG. 1, in accordance with an aspect described herein; and

FIG. 15 illustrates an example computing device suitable for use by components of FIG. 1, in accordance with an aspect described herein.

### DETAILED DESCRIPTION

Current systems for safeguarding confidential documents often struggle with accurately identifying the origins of leaked documents. This issue is exacerbated when the recovered artifact is a fragment or exists in a different format than the original, such as HTML (HyperText Markup Language, XML (Extensible Markup Language), or other like language used in emails and other documents. These languages render text differently based on various factors, such as browser type or email service provider, which can shift the relative positions of words and alter the original spacing characteristics. For example, an email rendered on a smartphone email service provider application will look different from an email displayed on a traditional web browser.

Techniques that rely on unique spacing patterns for source detection face challenges due to visual distortions introduced by imaging technologies like computer monitors, scanners, or camera phones. For instance, one conventional method increases the space between some words in a document while decreasing the space between other words in a document. To avoid creating visible changes, this is typically done in a net-zero manner, meaning that the same number of distance decreases and distance increases are applied so that the overall length of a line of text stays the same. However, distortions when these documents are rendered can alter the spatial elements of a document, making it difficult to match the artifact to its original source. For instance, the way an email is displayed can change based on user preferences for text alignment—justified, left-aligned, etc.—and these changes can obscure the encoded information used for source identification, along with offsetting the net-zero changes that might now be detected with the naked eye when rendered.

Methods that encode unique watermarks through spacing after specific characters, such as periods, are particularly vulnerable to changes in document formatting. Switching from left-aligned to justified text can distort these spacing patterns, making it challenging to identify the document's origin. Additionally, this approach is susceptible to fragmentation; if the artifact only contains a portion of the text with the encoded spacing signature, it may not provide enough data for accurate source identification due to the limited number of changes that can be made using this technique. Further, these methods suffer from font changes, since the spatial distance after certain characters changes as the shape of the character changes in response to using a different font.

Conventional spacing techniques also falter when dealing with resized or quality-reduced copies of the original document. For example, a document resized to 75% of its original dimensions or reduced in DPI (dots per inch) can significantly affect the reliability of methods that depend on specific spacing distances or character features for source detection. This could introduce some level of inaccuracy, undermining the effectiveness of these traditional approaches.

To solve these problems, aspects of the present technology apply changes to spatial elements based on bigrams when generating unique copies of original documents. The spatial changes can be applied consistently for common pairs of written units within bigrams and in a manner that distinguishes the unique copies. For instance, spatial elements separating written units of bigrams can be replaced with uniform character code characters, which provides metadata that includes character identifiers for the character rendered in the unique copy, thus allowing detection to be performed using the metadata when the metadata is captured in the artifact. However, even if the metadata is stripped from the artifact, detection can also be done by comparing the relative distances of the spatial elements in the artifact, assigning these relative distances a binary spacing indicator, and correlating these indicators to the original changes made in the unique copies. Such methods are more robust to detection when used with languages such as HTML, XML, or the like, and with certain documents, such as email communications, where the document often differs based on the rendering device and settings.

To generate unique copies of an original document using methods that achieve many of these benefits, bigrams within the original document are identified. Each bigram includes a pair of written units separated by a spatial element. In some cases, these spatial elements may be originally generated using ASCII (American Standard Code for Information Exchanges), which is one of the most common character encoding formats for text data in computers and on the internet. These spatial elements are replaced with two or more characters, such as spatial characters, from a uniform character code such as Unicode. The characters selected from the uniform character code can include two spatial characters, one having a relatively greater width than the other, but still visually similar under general observation. The spatial elements are replaced with two or more of the characters to create a unique sequence of bigram-character pairs, where each unique copy has a series of bigrams with a different pattern of characters using the two or more characters, thus forming a bigram code unique to that particular unique copy. This may be captured in a unique copy index, which includes the bigrams and character identifiers identifying the characters used to form the bigram-character pairs. The various unique copies are then distributed to recipients, where each recipient receives a different unique copy.

To determine the unique copy from which the artifact was derived, one or more detection methods may be employed. In some cases, the artifact includes metadata identifying the characters in the artifact, for instance, by identifying the character identifiers. This may occur as a result of reproduction methods that capture the original metadata from the unique copy, such as copying and pasting text from the unique copy into another uniform-character-code supported medium. When this occurs, the character identifiers are associated with their respective bigrams within the artifact. This can be done in a standardized format using an artifact index. The character identifiers of the bigrams of the artifact are compared to the character identifiers of respective bigrams of the unique copies. In particular, the correlation between the character identifiers of the bigrams of the artifact and the character identifiers of respective bigrams of the unique copies is determined. Pearson correlation can be used. The strength of the correlation indicates the likelihood that the artifact was derived from the unique copy. Thus, the highest correlated unique copy can be identified as the unique copy from which the artifact was derived.

In some cases, the artifact may be created in a manner that strips the metadata for the spatial characters, such as when an image of the artifact is taken, e.g., photograph, snapshot, snip, print, or the like. In such cases, detection of unique copy can still be done using the spatial elements between the bigrams of the artifact. Here, the bigrams of the artifact are again identified. The distance of the spatial element for each of the bigrams is measured. A binary spacing indicator can be used to represent the relative distance of the measured spatial elements. For instance, one indicator indicates that the width of the spatial element of the bigram is greater than the mean width of spatial elements for bigrams in the artifact, and another indicator indicates that the width of the spatial element of the bigram is less than the mean width of spatial elements for bigrams of the artifact. The binary spacing indicators may be stored in a structured way using an artifact index, which may comprise the bigrams and their associated binary spacing indicators. The binary spacing indicators applied to the bigrams can then be compared to the character identifiers of the unique copies. As noted, one character identifier identifies a spatial character that is wider than the other. As such, the correlations between the binary spacing indicators for bigrams of the artifact and the character identifiers of respective bigrams of the unique copies, based on the relative widths they represent, can be used to determine the unique copy from which the artifact was derived. The unique copy having the highest correlation to the artifact can be identified as the unique copy from which the artifact was derived. A Pearson correlation may be used for the comparison. Determining the correlation using bigrams of similar font sizes may further enhance the accuracy, relative to conventional methods, when identifying the unique copy from which the artifact was derived.

By comparing the spaces between bigrams, many of the problems inherent in the conventional methods can be solved. For instance, bigrams encoded in this way are robust to changes in the display size, which changes how text is wrapped. That is because only a few bigrams are broken from the rendering—those at the end of one line and begging with the next line—relative to the bigrams in the artifact as a whole. This issue is resolved because of the correlation methods that bigrams afford. Even though there are some bigrams that are broken, the correlation as a whole is still very strong due to the many unbroken bigrams. As such, even if the text wrapping changes, the correlation based on bigram spacing will still identify the unique copy. This is particularly beneficial for unique copies of documents that are susceptible to text wrapping changes.

Moreover, the disclosed technology enhances source detection for fragments as well. As noted, traditional methods tend to encode documents in a net-zero fashion. This makes it challenging to apply changes consistently, as the document text is different across the document. As such, various changes are made across the document, thus requiring a certain fragment size for identification. By applying spacing changes when using bigrams, the spacing changes can be made in a consistent manner. For instance, the same space change can be made to bigrams having common pairs of written units. This produces an index of bigrams with their respective characters, represented by character identifiers, which can be used to accurately detect source documents with fragments that are smaller compared to conventional methods.

The disclosed methods are also robust to font changes. That is, the relative distance between bigrams can be captured and compared rather than the actual distance of the spatial elements. As such, these relative distances, represented by the binary spacing indicators, can still be compared to the character identifiers for the unique copies. Thus, methods disclosed herein enhance detection methods relative to conventional systems, especially in instances where the rendering device changes the font or the font is changed in the unique copy when generating the artifact.

Further, unlike some conventional methods that alter spacing between words, methods provided herein may impart metadata that allows for easy identification of spatial characteristics, e.g., those distinguished by a binary spacing indicator, in cases where the metadata is imparted to the artifact. This allows for a quick comparison of the metadata with information from the unique copies, rather than necessarily relying on OCR (optical character recognition) and spatial measurement techniques.

The techniques described herein are robust to impersonation attacks, i.e., a user impersonating another, since the sequence of marks is uniquely random. Thus, even if users were aware that documents are being marked using bigrams, the potential random combinations make it challenging to subvert. The probability of guessing another user's marks are exceedingly rare for a long enough message, and becomes exponentially more complex as the number of words increases. For example, in a message with only 20 words and 10 recipients, there would be a 1 in 100,000 chance of guessing a valid mark sequence.

It will be realized that the method previously described is only an example that can be practiced from the description that follows, and it is provided to more easily understand the technology and recognize its benefits. Additional examples are now described with reference to the figures.

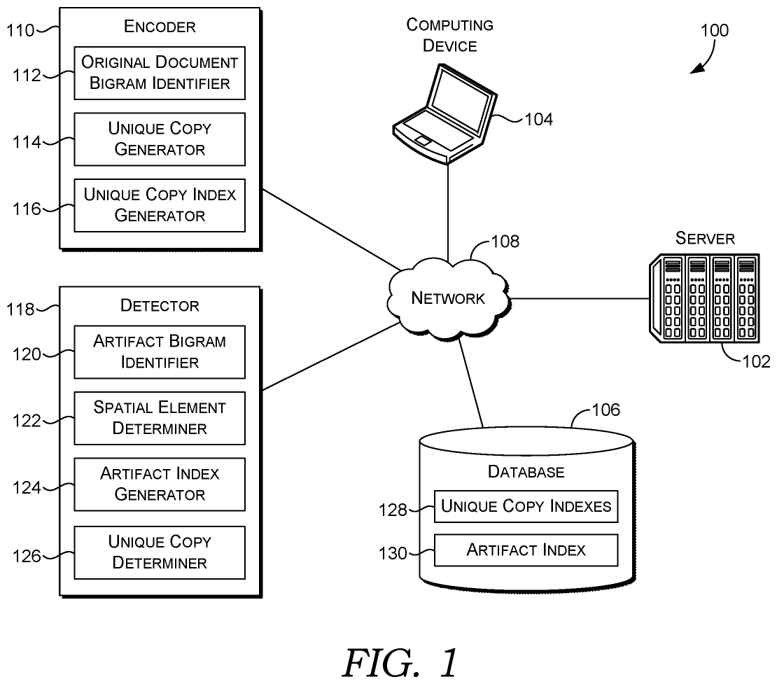

With reference now to FIG. 1, an example operating environment 100 in which aspects of the technology may be employed is provided. Among other components or engines not shown, operating environment 100 comprises server 102, computing device 104, and database 106, which are communicating via network 108 to encoder 110 and detector 118.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

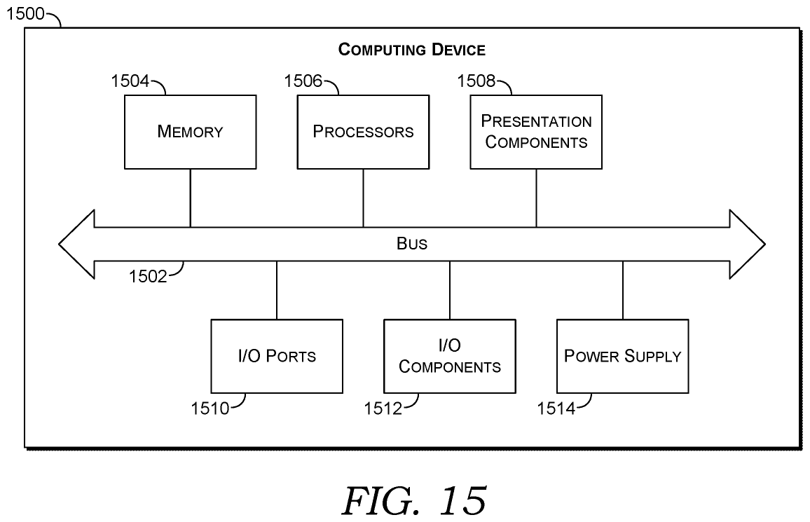

Generally, server 102 is a computing device that implements functional aspects of operating environment 100, such as one or more functions encoder 110 or detector 118. One suitable example of a computing device that can be employed as server 102 is described as computing device 1500 with respect to FIG. 15. In implementations, server 102 represents a back-end or server-side device.

Computing device 104 is generally a computing device that may be used to perform aspects of the disclosed technology. For instance, computing device 104 may be used to provide an original document from which unique copies are generated and distributed. In aspects, computing device 104 may be used to determine a unique copy from which an artifact was derived.

As with other components of FIG. 1, computing device 104 is intended to represent one or more computing devices. One suitable example of a computing device that can be employed as computing device 104 is described as computing device 1500 with respect to FIG. 15. In implementations, computing device 104 is a client-side or front-end device. In addition to server 102, computing device 104 may implement functional aspects of operating environment 100, such as one or more functions of encoder 110 or detector 118. It will be understood that some implementations of the technology will comprise either a client-side or front-end computing device, a back-end or server-side computing device, or both executing any combination of functions from encoder 110 or detector 118, among other functions.

As noted, aspects of operating environment 100 are suitable for encoding original documents using spacing techniques to generate unique copies that are distributed to various recipients. Encoder 110 may be employed to generate the unique copies. Encoder 110 encodes unique information within unique copies of an original document by making one or more perturbations between the original document and the unique copies, such as by replacing a spatial element with a character from a uniform character code. Further, aspects of the technology provide for detection methods. Here, an artifact derived from one of the unique copies can be used to determine the unique copy from which it was derived, thereby identifying a possible source of a data leak.

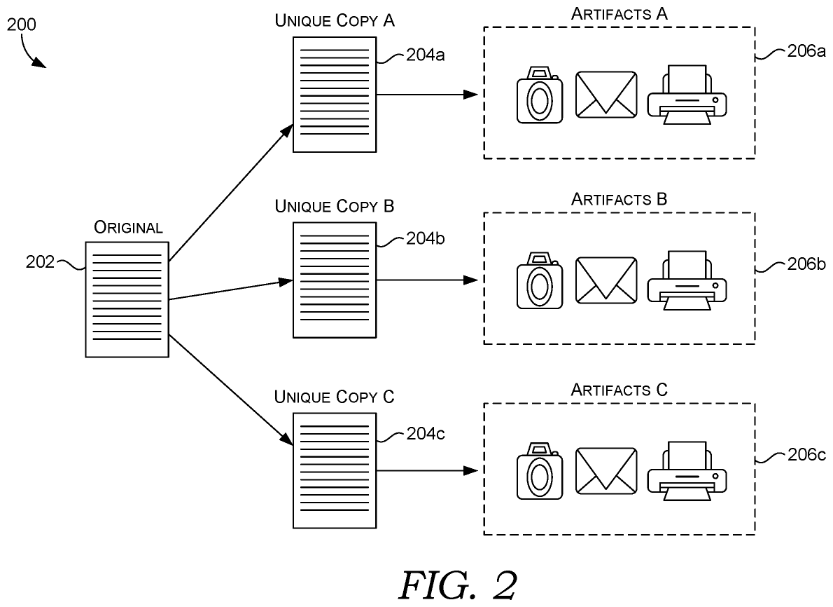

FIG. 2 illustrates an example set of unique copies that has been generated using encoder 110 and artifacts derived from these unique copies. FIG. 2 illustrates original document 202. Generally, an original document, such as original document 202, may be any document type that conveys content therein, such as text, images, tables, graphs, and so forth. For example, documents, including original documents, unique copies, artifacts, and so forth, can include various file types, such as JPEG (Joint Photographic Experts Group), GIF (graphics interchange format), SVG (scalable vector graphics), PNG (portable network graphic), BMP (bitmap), TIFF (tagged image file format), PDF (portable document format), Word document (e.g., DOC, DOCX), HTML, XML, spreadsheets (e.g., XLS or XLSX), text files (e.g., TXT, WPD), PowerPoint (e.g., PPT, PPTX), ODP (open document presentation), KEY (Keynote file), message file (MSG), and email (EML), among other document types.

In an embodiment of the technology, an original document, such as original document 202, is an email or other like communication and comprises language such as XML or HTML. In particular, these languages, and those similar to them, are highly susceptible to changes when rendered. That is, text provided in these languages may be displayed differently based on the type of display device, the size of the display device, the preferences of the computing device rendering the text, and so forth. As an example, an email service provider can provide a window in which an email in these languages may be displayed. As the window size is changed, the text will wrap from line to line at different points, changing the relative location of the text and the spacing between them. Further, these languages may be presented or changed with preferences to render differently, such as by changing from left alignment to justification, which again changes the relative position of the text and changes the spacing between the words of the text.

Unique copies, such as unique copies 204a-204c, are copies of an original document, such as original document 202, in which encoder 110 has made a perturbation, such as by replacing a spatial element with a character selected from a uniform character code. Unique copies are unique in that one unique copy has a different perturbation between the original and the unique copy relative to another unique copy. Thus, for instance, a unique copy can have a combination of spatial characters that is different from the combination of spatial characters in the other unique copies. In this way, there is a distinctive feature for each of the unique copies. Encoder 110 may mark each of the unique copies with one or more perturbations, giving them a distinctive watermarking that can be used to individually distinguish each unique copy. These perturbations may be applied in a manner that is challenging to detect with the human eye, but can be identified by a computing device to identify the unique copy from the others.

As an example, one or more perturbations, i.e., changes, made by encoder 110 to an original document to generate a unique copy may include changes in spacing between words of the text. For instance, the spacing between some words may be different than the spacing between other words. Put another way, the spatial element separating words may have a greater width between some words relative to others. Various combinations of the spacing may be applied to create a unique code, e.g., a unique watermark or signature that distinguishes one unique copy from the other unique copies. The spacing width may be such that it is challenging to detect with the human eye, but can be detected by a computing device, such as by measuring the pixel distance or identifying character identifiers for characters of different widths, as defined by a uniform character code.

Any number of perturbations to a unique copy can be made, and any one or more types of changes can be made when generating a unique copy. Various changes may be made throughout a document when generating a unique copy so that individual fragments of the unique copy can be used to positively identify the unique copy. Moreover, while changes to the spacing between words of the text is generally discussed in the context of the technology described herein, other types of perturbations may be made to further distinguish the unique copies, including changes to the terms used in the text itself, to margin or line spacing, and so on. Methods for making perturbations, including word-spacing, may be used as the sole method for generating unique copies or may complement any one or more additional perturbation methods to apply a distinct watermark in generating a unique copy.

Some examples may be found in U.S. patent application Ser. No. 18/179,635, filed on Mar. 7, 2023, entitled “Information Source Detection Using Unique Watermarks,” and U.S. patent application Ser. No. 18/295,710, filed on Apr. 4, 2023, entitled “Document Marking Techniques using Semantically Similar Phrases for Document Source Detection,” each of which is hereby expressly incorporated by reference in its entirety.

Unique copies, such as unique copies 204a-204c, can be distributed to individual recipients. Thus, each recipient receives a unique copy of the original document that is unique to the recipient. Unique copies may be provided in any manner, such as a printed document, an email attachment, a message body, or other like delivery method. In a specific example, an email is provided via an email service provider and is communicated to recipients. A mapping (e.g., a data index) can be kept to indicate an association between a unique copy and a recipient, thus allowing identification of a recipient via the mapping when the unique copy is known, e.g., has been identified from an artifact.

Some example artifacts are also illustrated in FIG. 2 as artifacts 206a-206c. In general, artifacts are derivations of a unique copy. As illustrated in FIG. 2, artifacts A 206a have been derived from unique copy A 204a, artifacts B 206b have been derived from unique copy B 204b, and artifacts C 206c have been derived from unique copy C 204c.

In general, an artifact, such as those illustrated, can be any derivation, in whole or in part, from a unique copy. For instance, an artifact may be a whole document of the same file type. For example, this may occur if a unique copy is attached to an email or included in the body of an email that is then forwarded to another recipient. An artifact may be a fragment of a unique copy that is the same file type. As an example, if a portion of a PDF document is provided to someone other than the initial recipient as a PDF, the portion provided is an artifact of the unique copy. In another example, the artifact may be a whole or partial replication of a unique copy that is in a different format. For instance, a photo, snip, or cut-and-paste of the unique copy can derive an artifact. Artifacts may be in the form of the computer-readable file formats, photos (including various angles), printed documents, copied and pasted content, email attachments, and other like derivations. Artifacts may include compound artifacts, such as those artifacts having multiple or combinations of derivations from the unique copy. For instance, these artifacts could include a photo of a printed version of a unique document, or a document that has been converted through various file formats.

As will be further described, artifacts may be generated via various methods. In some, cases, the method in which the artifact was generated may preserve certain textual information about the unique copy from which it was derived, such as metadata identifying aspects of the text. For instance, this may include an identification of the uniform character code that was used to generate the text, also called “characters” in this case. The characters forming the text, as generated using the uniform character code, can include character identifiers that identify the character that will be rendered from the font code of the uniform character code. The character identifiers are preserved in the metadata. In other artifacts, the creation method may have excluded the character identifier information, such as converting the unique copy to a pdf document or printing the unique copy onto a physical medium.

Turning back to FIG. 1, when generating unique copies, encoder 110 may employ original document bigram identifier 112, unique copy generator 114, and unique copy index generator 116. In general, encoder 110 generates unique copies by applying perturbations in the form of replacing spatial elements identified between bigrams in the original document with characters from a uniform character code.

In general, a bigram is a contiguous sequence of two adjacent elements extracted from a larger set of ordered elements, commonly employed in the context of text data. In this setting, the elements may constitute written units, such as alphabetic characters, syllables, or whole words. In aspects, a bigram represents a pair of written units that is separated by a spatial element.

A spatial element in the context of text generally refers to the measurable distance or space that exists between a pair of written units within a document, such as an original document, unique copy, or artifact. This distance can be quantified in various units of measurement, such as points, pixels, ems, or the like. A spatial element may be subject to variations based on factors such as font type, text alignment (e.g., left-aligned, justified), and user- or system-defined settings. In many cases, a spatial element is generated in various markup languages or uniform character codes. In a specific aspect, spatial elements in an original document, such as an email, are generated using simple text-encoding standards like ASCII, where spatial elements might be represented by space characters, tab characters, or other control characters. However, spatial elements may be rendered in any manner, including using Unicode, which is supported by HTML, XML, JSON (JavaScript Object Notation), and other languages.

To identify bigrams in the original document, encoder 110 employs original document bigram identifier 112. Original document bigram identifier 112 may use various software toolkits that can assist in identifying bigrams from an original document. One example is Tesseract, which is an open source OCR engine. As an example, the OCR process may be run on the original document to tokenize the text. The text may be tokenized into written units, such as words, separated by a spatial element. Original document bigram identifier 112 may then identify bigrams from contiguous sequences of two written elements. Identified bigrams may overlap, meaning that one written unit might be included in two bigrams.

As an example, given the sentence, “The cat jumped over the fence.”, tokens based on written units result in the following list: [“The”, “cat”, “jumped”, “over”, “the”, “fence.”]. Bigrams can be identified from this list as follows: [(“The”, “cat”), (“cat”, “jumped”), (“jumped”, “over”), (“over”, “the”), (“the”, “fence.”)]. As noted, some of the bigrams may overlap. For instance, “cat” is included in both bigrams (“The”, “cat”) and (“cat”, “jumped”). In aspects, original document bigram identifier 112 preserves punctuation and special characters. In this example, the period has been preserved in (“the”, “fence.”).

In aspects, original document bigram identifier 112 excludes written units that cross block boundaries as bigrams. For example, a word at the end of a paragraph may not be included in a bigram with the first word of the next paragraph based on a hard return between the two words. This may be done on any level, including, for instance, on a line-by-line level where the last word in a line is not included in a bigram with the first word of the next line; on a paragraph level, where the last word in a paragraph is not included in a bigram with the first word of the next paragraph; on a page level, where the last word of a page is not included in a bigram with the first word of the next page; and so forth.

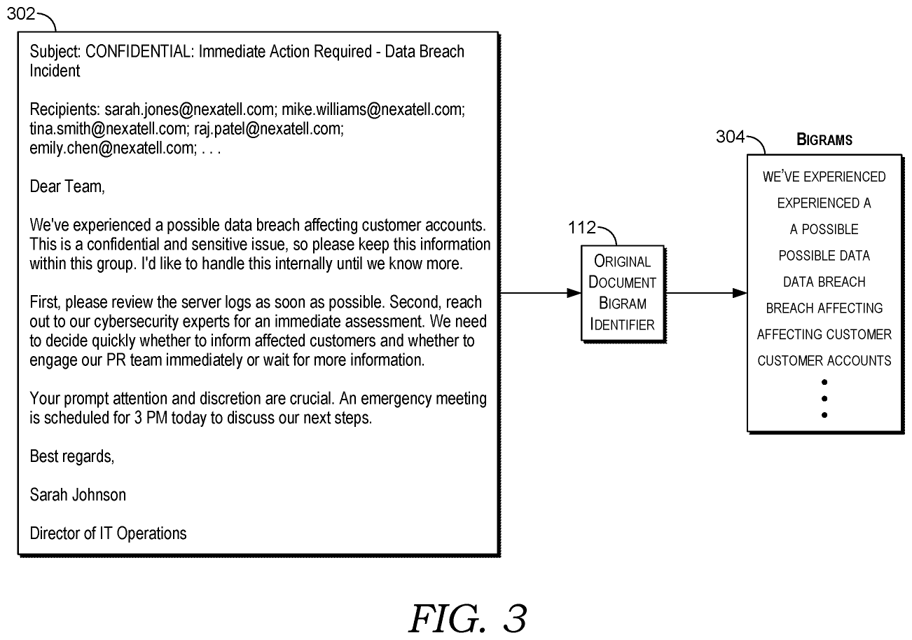

FIG. 3 illustrates an example that will be referred to throughout to help describe aspects and benefits of the technology. In this example, original document 302 is an email sent out to various recipients and includes confidential information, thus representing the type of information that a company may wish to keep internally secure until further details can be determined. As such, the technology described herein may be used to create unique copies of original document 302 to help discourage malicious leaks and help identify the source should a leak occur.

Looking at FIG. 3, original document bigram identifier 112 identifies bigrams from original document 302. Some select examples of the identified bigrams include bigrams 304. Original document bigram identifier 112 can employ methods previously described to generate bigrams, including bigrams 304.

Turning back to FIG. 1, unique copy generator 114 may be employed to generate unique copies from an original document. In general, unique copy generator 114 generates unique copies by replacing spatial elements in the original document with characters from a uniform character code. In aspects, the spatial elements replaced are those separating written units of the pairs of written units in the bigrams identified by original document bigram identifier 112. Two or more characters may be selected from the uniform character code and used to replace the spatial elements. Any number of spatial elements in the original document may be replaced when generating unique copies, including all of the spatial elements corresponding to identified bigrams or any portion thereof.

When replacing the spatial elements of the original document, unique copy generator 114 may select two or more space characters from the uniform character code. In aspects, a uniform character code includes a coding method for rendering characters. In some uniform character codes, each character is represented by a code point that can be encoded into a sequence of bytes and transmitted over a network. Typically, different computing devices and programming environments support the uniform character code and thus have access to algorithms that identify the code point and render the character from it. One example uniform character code is Unicode. Other uniform character codes that render characters or symbols common to the English language or any other language, or graphic-image characters like emojis, may also be suitable for use with the technology, including but not limited to Shift JIS, EUC-JP, and ISO-2022-JP, for use with some Japanese characters; GB2312, GBK, and GB 18030, for use with some Chinese characters; KOI8-R, for Cyrillic alphabets; or other like character coding systems. In some cases, space characters, e.g., those typically found separating words, may be selected from these or other uniform character codes for use with the technology.

While reference is made throughout of replacing spatial elements with uniform character code characters, in some implementations of the technology, spatial elements may be replaced with uniform character code characters, other methods may be used as well. In general, any spatial component that can be measured or tracked may be used, such as selecting characters from a uniform character code; kerning/tracking in HTML; positioning in PDF; CSS (Cascading Style Sheets) techniques such as letter-spacing, word-spacing, Flexbox, and Grid layout models; PDF operators and commands; vector graphic spacing (VGS); TeX and LaTeX spacing commands; and the like.

In a specific example suitable for use, unique copy generator 114 replaces spatial elements with two or more characters selected from the Unicode code set. Space characters can be selected that are relatively close in width, thus helping to visually obscure changes to a document when viewed with the naked eye. Two characters that may be used from Unicode are represented by their code points \u2004 and \u2005, as \u2004 renders a 0.25 em space character and \u2005 renders a 0.33 em space character.

Unique copy generator 114 replaces spatial elements from an original document in a manner where each unique copy has a different combination of bigram-character pairs. That is, each bigram is separated by a spatial element and may be replaced with one of the characters. In aspects, the same bigram is replaced with the same character in each instance it occurs in the original document. Put another way, each bigram from the original document having common pairs of written units is given the same character in each instance it occurs when generating a unique copy. For example, in a single unique copy, each instance of a bigram having a common pair of written units has the same space character.

Each unique copy may be represented by the same set of bigrams, but a different set of bigram-character pairs. That is, unique copy generator 114 can create various combinations of characters for the same set of bigrams, such that each combination of characters is different from combinations of characters for the other sets of bigrams. Each unique copy is generated having a specific bigram code comprising a unique set of bigram-character pairs, thus individually distinguishing one unique copy from other unique copies. Said differently, the original document and each unique copy may share the same set of bigrams, as the unique copies typically include the same text as the original document. However, the bigrams of each unique copy may vary with respect to the replaced character, thus providing a unique set of bigram-character pairs relative to other unique copies.

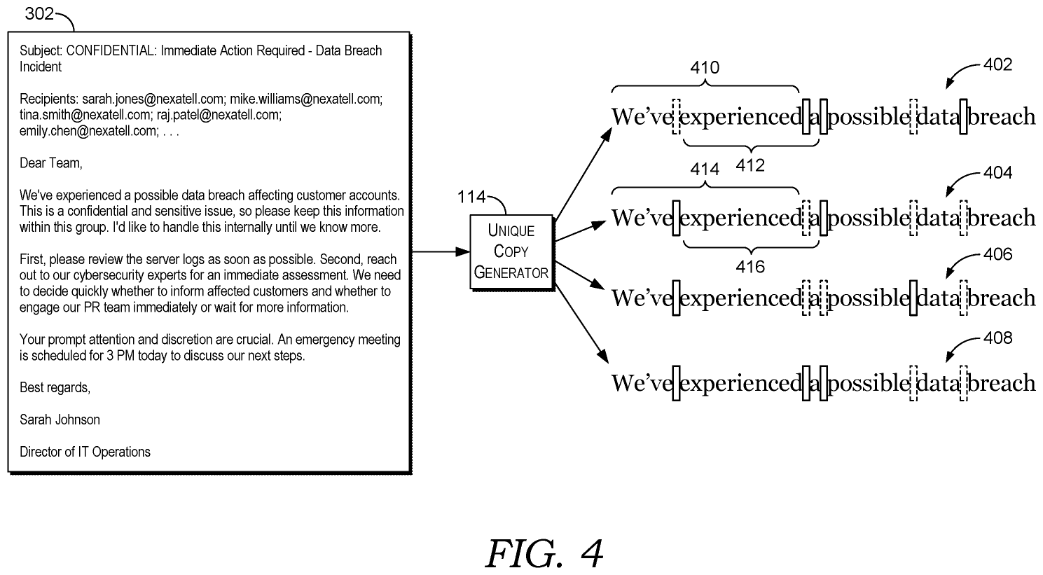

FIG. 4 illustrates an example using original document 302. As illustrated, unique copy generator 114 generates unique copies from original document 302 by replacing spatial elements from original document 302 with characters to form the unique copies. In the illustrated example, for purposes of illustration and clarity, only a portion of the unique copies generated using unique copy generator 114 are shown and designated unique copy A 402, unique copy B 404, unique copy C 406, and unique copy D 408. In each, the first six words of the first line in the body of original document 302 are illustrated. These six words form five bigrams, as illustrated in bigrams 304 in FIG. 3.

Continuing with FIG. 4, as can be seen in original document 302, a spatial element separates each of the bigrams. That is, a spatial element separates each of (“We've”, “experienced”), (“experienced”, “a”), (“a”, “possible”), (“possible”, “data”), (“data”, “breach”). When generating unique copies 402-408, unique copy generator 114 applies a different combination of characters, which can be represented by a different combination of character identifiers. In the illustrated example, each box represents a character selected from a uniform character code and rendered in the portions of unique copies 402-408. Here, a set of first characters is bound by dashed boxes representing space characters rendered from Unicode /u2005, which has a relatively greater width than a second set of characters corresponding to Unicode space characters rendered from /u2004, which are bound by solid boxes and have a width that is relatively less than the width of /u2005. To the naked eye, however, each of unique copies 402-408 is visually similar, although a computer may identify the width differences or may identify the character differences from metadata having first character identifiers corresponding to the first characters and second character identifiers corresponding to the second characters.

As illustrated, each bigram code of the unique copies 402-408 is different, thus making each of unique copies 402-408 unique from one another. In the illustration, a first bigram-character pair 410, illustrating the first pair of written units in unique copy A 402, comprises a space character rendered from u/2005, while the second bigram-character pair 412, illustrating the second pair of written units in unique copy A 402, comprises a space character rendered from u/2004. In contrast, a third bigram-character pair 414, illustrating the first pair of written units in unique copy B 404, comprises a space character rendered from u/2004, while the fourth bigram-character pair 416, illustrating the second pair of written units in unique copy B 404, comprises a space character rendered from u/2005. While visually each of these may appear similar when rendered, each includes a different bigram code comprising different bigram-character pairs, thus distinguishing unique copy A 402 and unique copy B 404. As noted, unique copy generator 114 may generate bigram-character pairs having a common pair of written units, e.g., the same words. In such cases, the spatial elements replaced to generate the bigram-character pairs are replaced with the same character. For example, each time the bigram (“a”, “possible”) occurs in unique copy A 402, unique copy generator 114 replaces the spatial element with the same character, u/2004. However, each time bigram (“a”, “possible”) occurs in unique copy C 406, unique copy generator 114 replaces the spatial element with the same character, u/2005.

It will be appreciated that the illustration provides only an example, and that describing each combination would be impractical. For instance, when replacing spatial elements with two characters, there are 2^{x} possible combinations of bigram-character pairs, where X is the number of unique bigrams in the original document. Thus, unique copy generator 114 could generate over 32,000 combinations of bigram-character pairs from a simple email with only 15 bigrams.

The bigram codes comprising variations of the bigram-character pairs can be stored in a unique copy index for use by other components when determining the unique copy from which an artifact was derived. Encoder 110 may employ unique copy index generator 116 to generate the unique copy index. In an aspect, unique copy index generator 116 generates a unique copy index that comprises the bigrams of the original document with duplicate bigrams removed. Unique copy index generator 116 generates the unique copy index to include the bigrams in association with character identifiers for one or more unique copies. As such, a unique copy index may include the bigrams from the original document associated with character identifiers identifying the characters of the bigram-character pairs in a unique copy.

In general, a character identifier identifies a character that is rendered or can be rendered using a uniform character code. In an aspect, a character identifier distinguishes one character from another. For instance, a plurality of character identifiers may be used to distinguish characters based on a width of the character. For instance, a first character identifier identifies a character having a first width. A second character identifier identifies a visually similar character having a second width that is greater than the first width. As such, the character identifiers may distinguish characters based on the rendered characters' widths relative to other character identifiers. A character identifier may be any number, letter, or sequence thereof that individually identifies the character. In an aspect, such as those illustrated in some of the provided examples, a character identifier is a code point for a particular character of a uniform character code. However, character identifiers can include any other number, letter, or sequence that identifies the rendered character, including a universal standard identifier or a unique identifier given for a particular task or program.

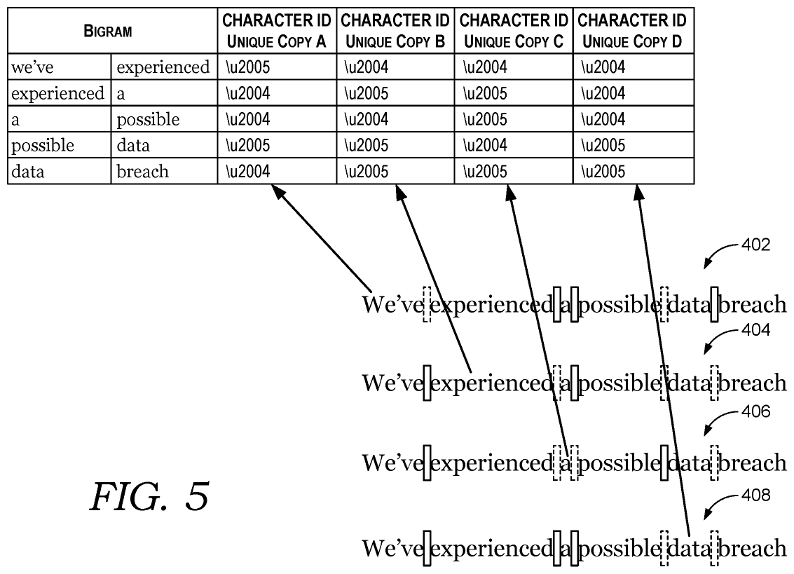

FIG. 5 illustrates an example of how a unique copy index is generated for unique copies 402-408. This may be done using unique copy index generator 116. In the illustrated example, each bigram for a pair of written units in the unique copies 402-408 has a character identifier identifying the character of the corresponding bigram-character pair in the unique copies 402-408. In this example, the code point for the characters has been used, but other identifiers could be used as well. In this example, unique copy index A 502 is generated for unique copy A 402, unique copy index B 504 is generated for unique copy index B 504, unique copy index C 506 is generated for unique copy C 406, and unique copy index D 508 is generated for unique copy D 408. As such, each index stores the bigram code for a respective unique copy. As used herein, distinction is not made between “index” and “indexes.” For instance, aspects of the technology could include a single index for each unique copy. In other aspects, such as the one illustrated in FIG. 5, a single index may include multiple indexes, one for each unique copy. The singular or plural use of the term “index” as used throughout this disclosure, or in the illustrated examples in FIG. 5 or others, is not intended to limit the technology to a specific structured data type or arrangement, or number thereof. Having generated indexes for the unique copies, the indexes can be stored in database 106 as unique copy indexes 128 for use by other components of FIG. 1.

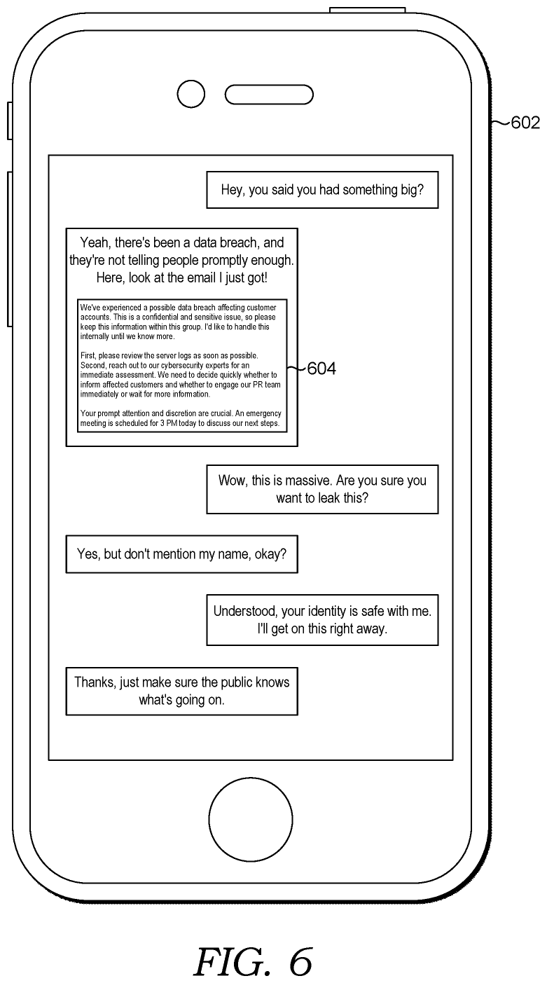

In the event that a unique copy has been leaked, detector 118 can be employed to help determine the source of the leak, e.g., which unique copy is associated with the leak and the recipient of that unique copy. FIG. 6 illustrates an example malicious leak in accordance with the example provided throughout this disclosure. Here, communication device 602 has been used to capture a portion of a unique copy generated from original document 302. This is illustrated in FIG. 6 as artifact 604. Various methods may have been used to create artifact 604, such as a copy-and-paste function, screen shot, photograph, or another like method. Various methods performed by detector 118 can determine the unique copy from which artifact 604 was derived.

Referring back to FIG. 1, in the illustrated example, detector 118 employs artifact bigram identifier 120, spatial element determiner 122, artifact index generator 124, and unique copy determiner 126 to generally determine from which unique copy an artifact has been derived. In general, this may be done by identifying bigrams in the artifact and determining the correlation between spatial elements of bigrams in the artifact and space characters in the unique copies. The unique copies can be ranked based on this correlation. The highest ranking unique copy is the most likely candidate unique copy, and may be identified as the unique copy from which the artifact was derived.

Upon accessing an artifact, detector 118 may employ artifact bigram identifier 120 to identify bigrams within the artifact. Detector 118 may use any of the techniques described with reference to original document bigram identifier 112. However, in brief, one example method includes applying OCR to the artifact to identify tokens, such as individual words separated by a spatial element. Detector 118 may identify bigrams from two contiguous tokens within the artifact. As noted, in some cases, special characters or punctuation are preserved when identifying bigrams. Each identified bigram within the artifact may include a pair of written units separated by a spatial element.

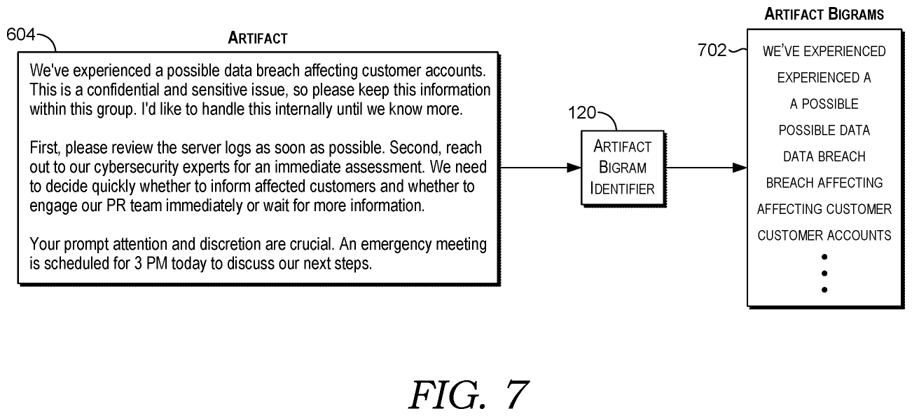

FIG. 7 illustrates an example. Here, artifact bigram identifier 120 is employed to identify bigrams within artifact 604. The identified bigrams include artifact bigrams 702. As will be understood, these are just some examples determined from artifact 604. As illustrated, some of the identified bigrams, including those illustrated in artifact bigrams 702, comprise (“We've”, “experienced”), (“experienced”, “a”), (“a”, “possible”), (“possible”, “data”), (“data”, “breach”), (“breach”, “affecting”). Each of these is separated by a spatial element in artifact 604.

Turning back to FIG. 1, spatial element determiner 122 can be employed to generally determine the spatial element of the bigram in an artifact. As noted, a spatial element may be a character from a uniform character code. In other instances, the spatial element may be another spatial feature applied within the artifact, such as margin, padding, letter-spacing, and word-spacing using CSS in HTML, XML, or other supporting language; HTML spacing using entities like &nbsp, &ensp, &emsp; ASCII characters; or other specialized software features for generating spaces in a document. In aspects, such as photographs, snips, or other like artifact generation methods, a spatial element may be a measurable distance between two written units of a bigram.

In aspects, spatial element determiner 122 determines the spatial elements within an artifact using metadata associated with the artifact. That is, some reproduction methods used to generate an artifact preserve metadata, which may include information related to the text of the artifact, such as character identifiers. In such cases, spatial element determiner 122 identifies the character identifiers from the metadata for space characters separating bigrams. As noted, the spatial element may include the code point or other identifier individually identifying the space characters.

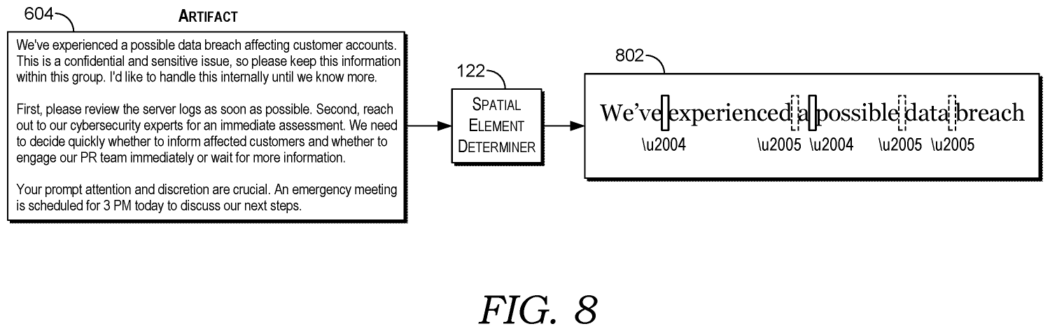

FIG. 8 illustrates an example. Here, spatial element determiner 122 has identified some select example spatial elements within artifact portion 802 of artifact 604. The character identifier for the spatial element in the bigram (“We've”, “experienced”) has been identified as Unicode character code/u2004, while the character identifier for the spatial element in the bigram (“experienced”, “a”) has been identified as another Unicode character code/u2005, and so forth. As noted, spatial element determiner 122 may have identified these using metadata corresponding to artifact 604.

In an aspect, the character identifiers are determined from the width of the spatial element. As will be described, the distance between a pair of written units in a bigram can be measured. Where this distance corresponds to a uniform distance of a character of a uniform character code, spatial element determiner 122 may associate a character identifier with that particular width and assign the character identifier to each spatial element having the width measuring the uniform distance.

In an aspect, spatial element determiner 122 determines a distance of the width of a spatial element and assigns the spatial element an indicator that identifies the relative width. For example, spatial element determiner 122 may measure the width of a spatial element and assign it a binary spacing indicator based on its width relative to the widths of other spatial elements in a document, such as an artifact.

As an example, the width of each spatial element for the bigrams in an artifact can be measured. The mean width may be determined. For each spatial element, the width of the spatial element is compared to the mean width. Where the width of the spatial element is greater than the mean width, spatial element determiner 122 assigns a first binary spacing indicator to represent the spatial element. Where the width of the spatial element is less than the mean width, spatial element determiner 122 assigns a second binary spacing indicator, which is different from the first binary spacing indicator, to represent the spatial element. In this example, there are two binary spacing indicators; however, it will be realized that any number of a plurality of spacing indicators may be assigned. When binary spacing indicators are used, one example binary spacing indicator set is (0, 1).

One example method that may be employed by spatial element determiner 122 to measure the distance of a spatial element comprises using an OCR algorithm and measuring the pixel distance. Other measurement systems may be used, however, the pixel distance is provided as a suitable example technique. For instance, OCR systems can tokenize words in a document, such as an artifact. Moreover, tools like Tesseract or Google Cloud Vision may be used to provide the coordinates of bounding boxes around each recognized written unit. For example, these may be in the form of (x, y) coordinates and may include coordinates for corners or edges of the bonding boxes, for example, the top-left and bottom-right corners of each box. Measuring the space between the two bounding boxes around the written units of a bigram provides the width of the spatial element of that bigram. One measurement method subtracts the x-coordinate of the top-left corner of the second word's bounding box from the x-coordinate of the bottom-right corner of the first word's bounding box. This provides the horizontal pixel distance between the two bounding boxes, which represents the width of the spatial element. This may be done for all, or a portion of, the bigrams in the artifact. For some methods, the mean distance may be determined to find the mean width of the spatial elements of the bigrams. Further, in some cases, measures of correlation can be sensitive to multimodal data. As such, bigram correlations between an artifact and a unique copy may be more accurately determined when computed over bigrams of similar font sizes. Thus, before correlations are determined, the artifact may be segmented into homogenous text blocks using the OCR software, as such segmentation methods are standard in many OCR programs. When segmenting the artifact into text blocks, the correlations between the artifact and the unique copy may be determined per block and combined with a weighted average based on the number of bigrams in the block.

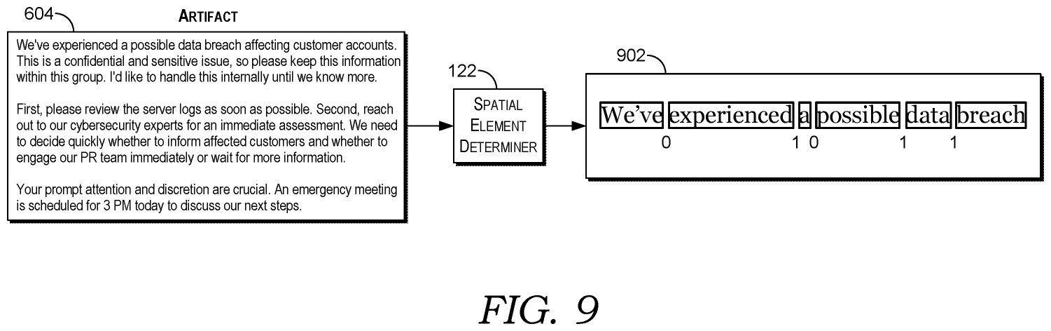

FIG. 9 illustrates an example of spatial element determiner 122 assigning indicators to spatial elements based on the widths of the spatial elements for artifact portion 902 of artifact 604. In this example, bounding boxes have been placed around each written unit. The distance between the bounding boxes is measured, and the mean distance is determined, thus providing the mean width of the spatial elements. Each spatial element is assigned an indicator of a set of binary spacing indicators comprising (0, 1) based on the width of the spatial element relative to the mean width. For instance, in the bigram (“We've”, “experienced”), the width of the corresponding spatial element is less than that of the mean width, and thus, the spatial element has been assigned a 0, representing that the width is relatively less than the mean. Further, in the bigram (“experienced”, “a”), the width of the corresponding spatial element is more than that of the mean width, and thus, the spatial element has been assigned a 1, representing that the width is relatively greater than the mean. This can be done for all of, or a portion of, the spatial elements, as selectively illustrated in FIG. 9.

Referring again to FIG. 1, an artifact index can be generated using artifact index generator 124 based on the information determined using spatial element determiner 122. Artifact index generator 124 may generate an artifact index comprising bigrams identified in the artifact, such as those identified using artifact bigram identifier 120, and any information determined by spatial element determiner 122, such as character identifiers or indicators, including binary spacing indicators. In an aspect, artifact index comprises the bigram associated with a character identifier or indicator that together correspond to a bigram separated by a spatial element in the artifact. In an aspect, artifact index generator 124 generates an artifact index that comprises the identified bigrams with duplicate bigrams removed. An artifact index generated by artifact index generator 124 may be stored in database 106 as artifact index 130 for use by other components of FIG. 1 in determining the unique copy from which the artifact was derived.

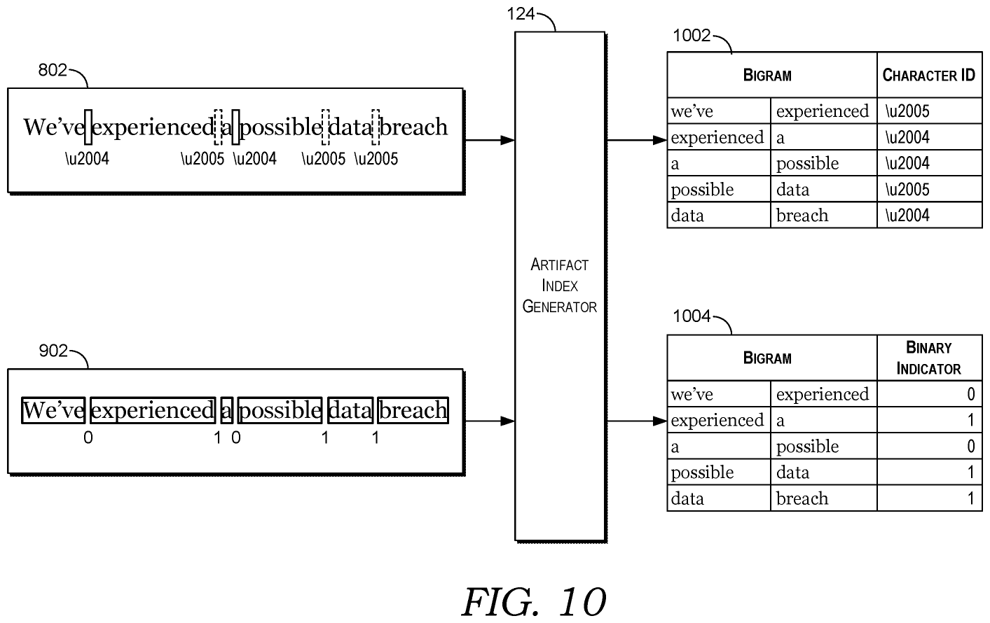

FIG. 10 illustrates an example of generating an artifact index using artifact index generator 124. In an example, artifact index generator 124 accesses the character identifiers from those determined in artifact portion 802, and indexes the character identifiers in association with the corresponding bigrams from the artifact. In doing so, artifact index generator 124 generates artifact index A 1002.

In another example, artifact index generator 124 accesses the binary spacing indicators determined in artifact portion 902 and indexes the binary spacing indicators in association with the corresponding bigrams from the artifact. In doing so, artifact index generator 124 generates artifact index B 1004. Either or both of the character identifiers and binary spacing indicators may be determined from an artifact and indexed using artifact index generator 124. It is again noted that the example illustrations are not intended to limit the data structure in which an artifact index or a unique copy index can be stored, but instead, are provided to illustrate an example of the technology suitable for use.

Referring back to FIG. 1, detector 118 employs unique copy determiner 126 to determine the unique copy from which an artifact was derived. For example, unique copy determiner 126 may compare the unique copy indexes 128 to artifact index 130 to determine the unique copy. In an aspect, unique copy determiner 126 determines a correlation between data within unique copy indexes 128 and artifact index 130.

In an aspect, unique copy determiner 126 compares the character identifiers corresponding to the characters separating bigrams of the unique copies to character identifiers of characters separating respective bigrams in the artifact. For example, the correlation is determined between the character identifiers of the unique copies, which may be included in unique copy indexes 128, and the character identifiers of the characters within the artifact. The correlation identifies the strength of the relationship between characters in the unique copy and characters in the artifact. For instance, a Pearson correlation may be used, which outputs a coefficient indicating the relative strength of the relationship. In this example, a correlation of 1 indicates a perfect match, and a correlation of 0 indicates no match, while −1 indicates an exact opposite match. Unique copy determiner 126 may rank the unique copies based on their correlation with the artifact, e.g., the correlation between the character identifiers of the unique copies and the character identifiers of the artifact. The unique copy having the strongest correlation, e.g., the highest ranked unique copy, is the most likely candidate match, and it can be determined by unique copy determiner 126 as the unique copy from which the artifact was derived.

In another aspect, unique copy determiner 126 compares the character identifiers corresponding to the characters separating bigrams of the unique copies to the indicators, such as the binary spacing indicators, corresponding to spatial elements separating respective bigrams of the artifact. As noted, a binary spacing indicator may represent the relative width of a spatial element separating written units of a bigram. In the example previously provided, a first binary spacing indicator of 1 represents a spatial element width that is relatively greater than that of a spatial element width for a second spatial element, represented with a 0. Likewise, a character identifier of the unique copies can represent characters having different widths. Thus, a first character identifier can represent a first space character having a width relatively greater than a second space character having a second character identifier. In such cases, the correlation is determined between the first binary spacing indicators and the first character identifiers that each represent relatively greater widths, and the second binary spacing indicators and the second character identifiers that each represent relatively smaller widths. Similarly, a Pearson correlation may be used. The unique copies can be ranked based on the strength of the correlation. The highest ranking, e.g., the unique copy with the strongest correlation, may be determined to be the unique copy from which the artifact was derived.

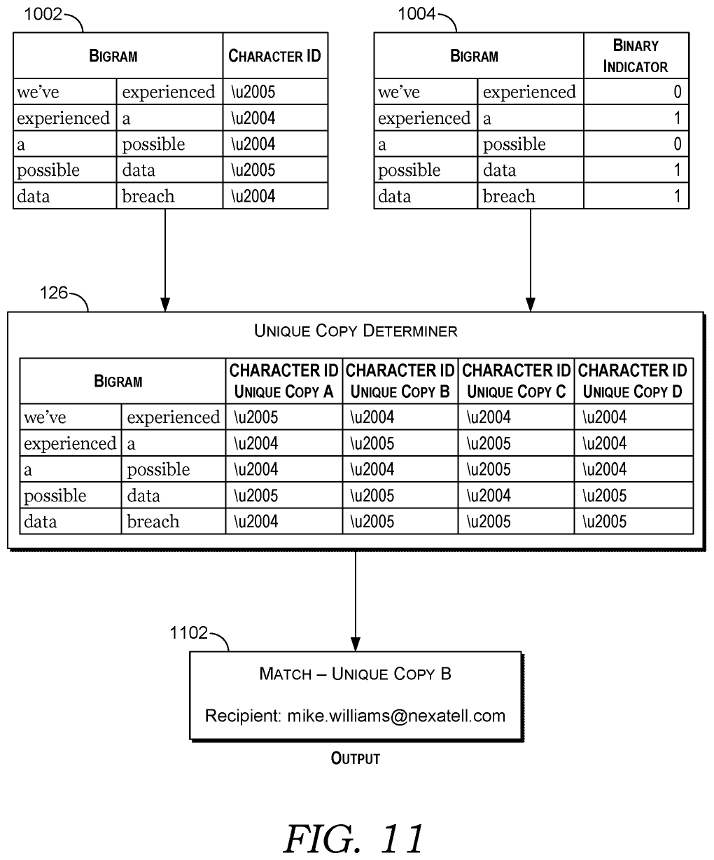

FIG. 11 provides an example using unique copy determiner 126 to determine that an artifact was derived from a unique copy. In the illustrated example, artifact index A 1002 is provided to unique copy determiner 126. As noted previously, artifact index A 1002 was generated from artifact 604. Here, the correlation between the character identifiers in artifact index A 1002 and the character identifiers of unique copies A-D are determined for respective bigrams. In doing so, unique copy determiner 126 determines that the strongest correlation is with unique copy B, relative to the other unique copies. As such, unique copy determiner 126 provides output 1102 that indicates that unique copy B is the unique copy from which artifact 604 was derived. In instances, unique copy determiner 126 may use the identification of the unique copy to determine the initial recipient of the unique copy, e.g., by recalling the recipient from a data index storing relationships between unique copies and recipients. In aspects, output 1102 comprises the identified initial recipient, as illustrated in FIG. 11.

In another embodiment, also illustrated by FIG. 11, unique copy determiner 126 is used to determine that artifact 604 was derived from unique copy B. Here, unique copy determiner 126 determines the correlation between the binary indicators in artifact index B 1004 and the character identifiers for unique copies A-D. For example, the correlation may be between the binary indicator 0 and character identifier /u2004, each representing a spatial element or character of relatively less width, and binary indicator 1 and character identifier /u2005, each representing a spatial element or character of relatively greater width for respective bigrams. In this example, unique copy B has a stronger correlation than the other unique copies. Thus, output 1102 identifies unique copy B as the unique copy from which the artifact was derived, and may identify and include the initial recipient of unique copy B.

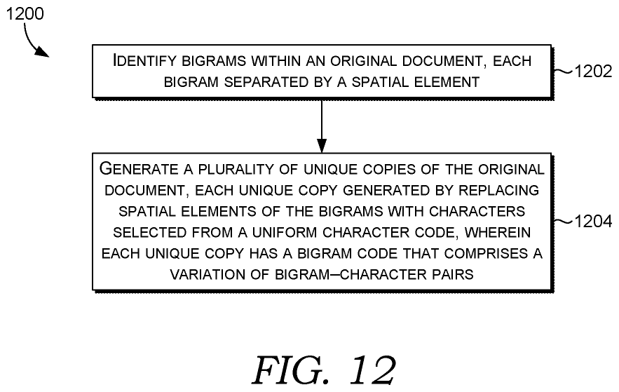

Turning now to FIG. 12, a block diagram of an example method 1200 for generating a plurality of unique copies of an original document is illustrated. Aspects of method 1200 may be performed using components of FIG. 1, such as encoder 110. In block 1202, bigrams within an original document are identified. This may be done by employing original document bigram identifier 112. Each bigram is separated by spatial element. Bigrams may comprise a pair of written units separated by a spatial element.

In block 1204, a plurality of unique copies of the original document is generated. This may be done using unique copy index generator 116. Each unique copy may be generated by replacing spatial elements of the bigrams with characters selected from a uniform character code. At least two characters may be selected. In an aspect, the characters are selected from Unicode. The characters may be space characters having different widths, with a width of the first character being greater than the width of the second character. In aspects, spatial elements separating bigrams having a common pair of written units are replaced with the same character. The bigrams replaced with the spatial element form bigram-character pairs within the unique copies when generated. Each unique copy comprises a different combination of bigram-character pairs, thus providing each unique copy with a different bigram code. Thus, each unique copy has a variation of bigram-character pairs unique from other bigram-character pairs of the unique copies.

In aspects, the bigram-character pairs are included in a unique copy index for each unique copy. The unique copy index may include bigrams from the original document associated with character identifiers corresponding to the bigram-character pairs of the unique copies. Duplicate bigrams may be removed. The indexed character identifiers associated with the bigrams of a unique copy represent the bigram code for the unique copy, distinguishing the unique copy from other unique copies.

In an aspect, the original document is in XML or HTML format. The original document may be an email. The unique copies may be generated in the same format as the original document. In an aspect, the original document comprises spatial elements defined by ASCII characters, and the spatial elements are replaced with Unicode.

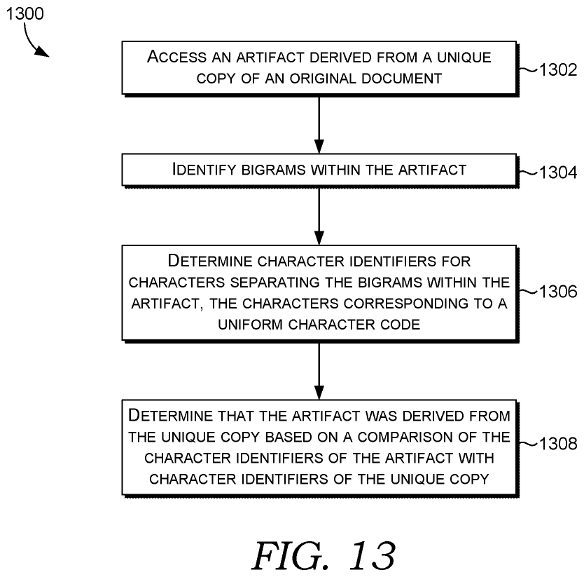

Referring now to FIG. 13, a block diagram having an example method 1300 for determining a unique copy from which an artifact was derived is illustrated. At block 1302, an artifact is accessed. The artifact may be derived from a unique copy of an original document. In an aspect, the artifact is in XML or HTML format.

At block 1304, bigrams within the artifact are identified. This may be done using artifact bigram identifier 120. Bigrams may include a pair of written units separated by a spatial element, which may be a character selected from a uniform character code. Characters may be in any format. Space characters in the artifact are in Unicode.

At block 1306, character identifiers for characters separating the bigrams within the artifact are identified. For instance, these may be identified based on metadata associated with the artifact comprising character information indicating the character identifiers corresponding to the characters separating the bigrams. In an aspect, the character identifiers are determined based on widths of the characters separating pairs of written units in the bigrams. In some cases, the character identifiers of the artifact include at least two space characters identifying at least a first uniform character code and a second uniform character code, where the space character of the first uniform character code is greater in width than the space character of the second uniform character code.

At block 1308, it is determined that the artifact is derived from the unique copy. The determination may be done by unique copy determiner 126. In an aspect, the determination is based on a comparison of the character identifiers of the artifact with character identifiers of the unique copy. A correlation, such as a Pearson correlation, can be done for the comparison.

For instance, an artifact index can be generated to include the bigrams and the character identifiers corresponding to the artifact. This can be compared to a unique copy index corresponding to the unique copy. For example, a correlation between the character identifiers of the artifact and the character identifiers of the unique copy may be determined for respective bigrams, e.g., those bigrams of the artifact that match those bigrams of the unique copy. Unique copies can be ranked based on a correlation. The highest ranked unique copy may be determined to be the unique copy from which the artifact was derived.

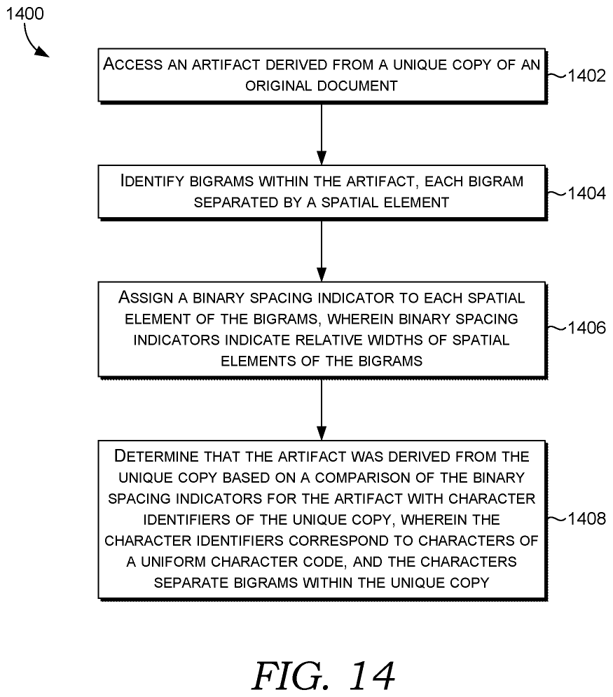

With reference now to FIG. 14, a block diagram with an example method 1400 for determining that an artifact was derived from a unique copy is illustrated.

At block 1402, an artifact is accessed. The artifact is derived from a unique copy of an original document. As an example, the artifact may be an image. The artifact may have no metadata identifying the spatial elements. In aspects, the unique copy may comprise a document in XML or HTML. In an aspect, the unique copy is an email. Thus, in an example aspect of the technology, the artifact is an image of an email.

In an aspect, the unique copy comprises space characters that can be represented by character identifiers. For example, the character identifiers of the unique copy may include at least two character identifiers identifying at least a first character of a uniform character code and a second character of a uniform character code. The first character and second character may correspond to a space character. The first character may be greater in width than the second character.

At block 1404, bigrams within the artifact are identified. Each bigram may comprise a pair of written units separated by a spatial element. This may be done by artifact bigram identifier 120.

At block 1406, a binary spacing indicator is assigned to each spatial element of the bigrams. The binary spacing indicators may indicate relative widths of spatial elements of the bigrams.

For example, in an aspect, a bounding box is applied to each written unit. An OCR system may be used to apply the bounding boxes. A distance between each bounding box, which represents the width of spatial elements of bigrams, can be measured. Spatial element determiner 122 assigns the binary spacing indicator to each spatial element based on the relative width of the spatial element. For instance, the width of a spatial element can be compared to a mean width of the spatial elements. A first binary spacing indicator may be used to indicate a spatial element width that is relatively greater than other spatial element widths in the artifact (e.g., a mean width), and a second binary spacing indicator may be used to indicate a spatial element width that is relatively less than the other spatial element widths in the artifact (e.g., the mean width).

At block 1408, it is determined that the artifact is derived from the unique copy. The determination may be based on a comparison of the binary spacing indicators for the artifact with character identifiers of the unique copy. The character identifiers of the unique copy may correspond to characters of a uniform character code, such as Unicode, where the characters separate bigrams within the unique copy to which the artifact is compared. The comparison may be performed by determining a correlation, such as a Pearson correlation.

In an aspect, the correlation is determined between the first character identifiers of the unique copy and first binary spacing indicators of the artifact, and the second character identifiers of the unique copy and second binary spacing indicators of the artifact.

With reference back to FIGS. 12-14, block diagrams are provided respectively illustrating methods 1200, 1300, and 1400. Each block of the methods may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. The methods may be implemented in whole or in part by components of operating environment 100.

Having described an overview of some embodiments of the present technology, an example computing environment in which embodiments of the present technology may be implemented is described below in order to provide a general context for various aspects of the present technology. Referring now to FIG. 15 in particular, an example operating environment for implementing embodiments of the present technology is shown and designated generally as computing device 1500. Computing device 1500 is but one example of a suitable computing environment and is not intended to suggest any limitation as to the scope of use or functionality of the technology. Computing device 1500 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 15, computing device 1500 includes bus 1502, which directly or indirectly couples the following devices: memory 1504, one or more processors 1506, one or more presentation components 1508, input/output (I/O) ports 1510, input/output components 1512, and illustrative power supply 1514. Bus 1502 represents what may be one or more buses (such as an address bus, data bus, or combination thereof). Although the various blocks of FIG. 15 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 15 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 15 and with reference to “computing device.”

Computing device 1500 typically includes a variety of computer-readable media. Computer-readable media can be any available media that can be accessed by computing device 1500 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1500. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1504 includes computer-storage media in the form of volatile or non-volatile memory. The memory may be removable, non-removable, or a combination thereof. Example hardware devices include solid-state memory, hard drives, optical-disc drives, etc. Computing device 1500 includes one or more processors that read data from various entities, such as memory 1504 or I/O components 1512. Presentation component(s) 1508 presents data indications to a user or other device. Example presentation components include a display device, speaker, printing component, vibrating component, etc.

I/O ports 1510 allow computing device 1500 to be logically coupled to other devices, including I/O components 1512, some of which may be built-in. Illustrative components include a microphone, joystick, game pad, satellite dish, scanner, printer, wireless device, etc. The I/O components 1512 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1500. Computing device 1500 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1500 may be equipped with accelerometers or gyroscopes that enable detection of motion. The output of the accelerometers or gyroscopes may be provided to the display of computing device 1500 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, components for encoding an original document to generate unique copies and detecting a unique copy from which an artifact was derived can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to encoder 110 or detector 118, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of encoder 110 or detector 118, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the forgoing description include the following:

Aspect 1: A method performed by one or more processors, the method comprising: identifying bigrams within an original document, each bigram separated by a spatial element; and generating a plurality of unique copies of the original document, each unique copy generated by replacing spatial elements of the bigrams with characters selected from a uniform character code, wherein each unique copy has a bigram code that comprises a variation of bigram-character pairs.

Aspect 2: Aspect 1, wherein each bigram comprises a pair of written units, and wherein, when generating each unique copy, spatial elements of bigrams comprising a common pair of written units are replaced with a same character selected from the uniform character code to form the bigram-character pairs.

Aspect 3: Any of Aspects 1-2, wherein the bigram code includes bigram-character pairs having a combination of character identifiers different from other bigram codes of the unique copies.

Aspect 4: Aspect 3, wherein the character identifiers of the unique copies include at least two character identifiers identifying at least a first uniform character code and a second uniform character code, each of the first uniform character code and second uniform character code corresponding to a space character, the space character of the first uniform character code being greater in width than the space character of the second uniform character code.

Aspect 5: Any of Aspects 1-4, further comprising generating a unique copy index for the unique copies, wherein unique copy indexes comprise the bigrams and character identifiers, corresponding to the bigram-character pairs, that define the bigram code, each unique copy index having a different bigram code.

Aspect 6: Any of Aspects 1-5, wherein the unique copies are in XML (extensible markup language) or HTML (hypertext markup language) format.

Aspect 7: Any of Aspects 1-6, wherein the spatial elements are ASCII characters, and the uniform character code, from which the characters are selected to replace the spatial elements, comprises Unicode.

Aspect 8: One or more computer storage media storing computer-readable instructions thereon that, when executed by a processor, cause the processor to perform a method comprising: accessing an artifact derived from a unique copy of an original document; identifying bigrams within the artifact; determining character identifiers for characters separating the bigrams within the artifact, the characters corresponding to a uniform character code; and determining that the artifact was derived from the unique copy based on a comparison of the character identifiers of the artifact with character identifiers of the unique copy.

Aspect 9: Aspect 8, wherein determining the character identifiers is based on a distance between pairs of written units forming the bigrams.

Aspect 10: Any of Aspects 8-9, wherein the artifact comprises metadata associated with the uniform character code, and the character identifiers for each of the bigrams are determined from the metadata.

Aspect 11: Any of Aspects 8-10, wherein determining that the artifact was derived from the unique copy further comprises: generating an artifact index, the artifact index comprising the bigrams and the character identifiers corresponding to the artifact; determining a correlation between the character identifiers in the artifact index and character identifiers in a unique copy index corresponding to the unique copy for respective bigrams; and determining that the artifact was derived from the unique copy based on the correlation.

Aspect 12: any of Aspects 8-11, wherein the artifact is in XML (extensible markup language) or HTML (hypertext markup language) format.

Aspect 13: Any of Aspects 8-12, wherein the character identifiers of the unique copy and the character identifiers of the artifact include at least two character identifiers identifying at least a first uniform character code and a second uniform character code, each of the first uniform character code and second uniform character code corresponding to a space character, the space character of the first uniform character code being greater in width than the space character of the second uniform character code.

Aspect 14: Any of Aspects 8-13, wherein the uniform character code for the characters of the artifact is Unicode.

Aspect 15: A system comprising: at least one processor; and one or more computer storage media storing computer-readable instructions thereon that when executed by the at least one processor cause the at least one processor to perform operations comprising: accessing an artifact derived from a unique copy of an original document; identifying bigrams within the artifact, each bigram separated by a spatial element; assigning a binary spacing indicator to each spatial element of the bigrams, wherein binary spacing indicators indicate a relative width of spatial elements of the bigrams; and determining that the artifact was derived from the unique copy based on a comparison of the binary spacing indicators for the artifact with character identifiers of the unique copy, wherein the character identifiers correspond to characters of a uniform character code, and the characters separate bigrams within the unique copy.

Aspect 16: Aspect 15, wherein the binary spacing indicators are assigned based on a width of a spatial element relative to a mean width of the spatial elements of the bigrams within the artifact.

Aspect 17: Any of Aspects 15-16, further comprising: applying a bounding box around each written unit of a pair of written units forming a bigram in the artifact; determining a distance between bounding boxes for the pair of written units, thereby determining the width of the spatial element for the bigram; and determining that the width is relatively less than or greater than a mean width of the spatial elements, wherein the binary spacing indicator indicates whether the width is relatively less than or greater than the mean width.

Aspect 18: Any of Aspects 15-17, wherein: the character identifiers of the unique copy include at least two character identifiers, a first character identifier identifying at least a first character of the uniform character code and a second character identifier identifying at least a second character of the uniform character code, each of the first character and the second character corresponding to a space character, the first character being greater in width than the second character; and the binary spacing indicators comprising at least two binary spacing indicators, a first binary spacing indicator indicating a spatial element width that is relatively greater than other spatial element widths in the artifact, and a second binary spacing indicator indicating a spatial element width that is relatively less than the other spatial element widths in the artifact; and the comparison comprises a correlation between: first character identifiers of the unique copy and first binary spacing indicators of the artifact; and second character identifiers of the unique copy and second binary spacing indicators of the artifact.

Aspect 19: any of Aspects 15-18, wherein the comparison of the binary spacing indicators for the artifact with the character identifiers corresponding to the characters of the uniform character code is performed using a Pearson correlation coefficient.

Aspect 20: Any of Aspects 15-19, wherein: the unique copy is in XML (extensible markup language) or HTML (hypertext markup language) format; and the artifact is an image.

What is claimed is:

1. A method performed by one or more processors, the method comprising:
identifying bigrams within an original document, each bigram separated by a spatial element; and
generating a plurality of unique copies of the original document, each unique copy generated by replacing spatial elements of the bigrams with characters selected from a uniform character code, wherein each unique copy has a bigram code that comprises a variation of bigram-character pairs.

2. The method of claim 1, wherein each bigram comprises a pair of written units, and wherein, when generating each unique copy, spatial elements of bigrams comprising a common pair of written units are replaced with a same character selected from the uniform character code to form the bigram-character pairs.

3. The method of claim 1, wherein the bigram code includes bigram-character pairs having a combination of character identifiers different from other bigram codes of the unique copies.

4. The method of claim 3, wherein the character identifiers of the unique copies include at least two character identifiers identifying at least a first uniform character code and a second uniform character code, each of the first uniform character code and second uniform character code corresponding to a space character, the space character of the first uniform character code being greater in width than the space character of the second uniform character code.

5. The method of claim 1, further comprising generating a unique copy index for the unique copies, wherein unique copy indexes comprise the bigrams and character identifiers, corresponding to the bigram-character pairs, that define the bigram code, each unique copy index having a different bigram code.

6. The method of claim 1, wherein the unique copies are in XML (extensible markup language) or HTML (hypertext markup language) format.

7. The method of claim 1, wherein the spatial elements are ASCII characters and the uniform character code, from which the characters are selected to replace the spatial elements, comprises Unicode.

8. One or more computer storage media storing computer-readable instructions thereon that, when executed by a processor, cause the processor to perform a method comprising:
accessing an artifact derived from a unique copy of an original document;
identifying bigrams within the artifact;
determining character identifiers for characters separating the bigrams within the artifact, the characters corresponding to a uniform character code; and
determining that the artifact was derived from the unique copy based on a comparison of the character identifiers of the artifact with character identifiers of the unique copy.

9. The media of claim 8, wherein determining the character identifiers is based on a distance between pairs of written units forming the bigrams.

10. The media of claim 8, wherein the artifact comprises metadata associated with the uniform character code, and the character identifiers for each of the bigrams is determined from the metadata.

11. The media of claim 8, wherein determining that the artifact was derived from the unique copy further comprises:
generating an artifact index, the artifact index comprising the bigrams and the character identifiers corresponding to the artifact;
determining a correlation between the character identifiers in the artifact index and character identifiers in a unique copy index corresponding to the unique copy for respective bigrams; and
determining that the artifact was derived from the unique copy based on the correlation.

12. The media of claim 8, wherein the artifact is in XML (extensible markup language) or HTML (hypertext markup language) format.

13. The media of claim 8, wherein the character identifiers of the unique copy and the character identifiers of the artifact include at least two character identifiers identifying at least a first uniform character code and a second uniform character code, each of the first uniform character code and second uniform character code corresponding to a space character, the space character of the first uniform character code being greater in width than the space character of the second uniform character code.

14. The media of claim 8, wherein the uniform character code for the characters of the artifact is Unicode.

15. A system comprising:
at least one processor; and
one or more computer storage media storing computer-readable instructions thereon that when executed by the at least one processor cause the at least one processor to perform operations comprising:
accessing an artifact derived from a unique copy of an original document;
identifying bigrams within the artifact, each bigram separated by a spatial element;
assigning a binary spacing indicator to each spatial element of the bigrams, wherein binary spacing indicators indicate a relative width of spatial elements of the bigrams; and
determining that the artifact was derived from the unique copy based on a comparison of the binary spacing indicators for the artifact with character identifiers of the unique copy, wherein the character identifiers correspond to characters of a uniform character code, and the characters separate bigrams within the unique copy.

16. The system of claim 15, wherein the binary spacing indicators are assigned based on a width of a spatial element relative to a mean width of the spatial elements of the bigrams within the artifact.

17. The system of claim 15, further comprising:
applying a bounding box around each written unit of a pair of written units forming a bigram in the artifact;
determining a distance between bounding boxes for the pair of written units, thereby determining the width of the spatial element for the bigram; and
determining that the width is relatively less than or greater than a mean width of the spatial elements, wherein the binary spacing indicator indicates whether the width is relatively less than or greater than the mean width.

18. The system of claim 15, wherein:
the character identifiers of the unique copy include at least two character identifiers, a first character identifier identifying at least a first character of the uniform character code and a second character identifier identifying at least a second character of the uniform character code, each of the first character and the second character corresponding to a space character, the first character being greater in width than the second character;
the binary spacing indicators comprising at least two binary spacing indicators, a first binary spacing indicator indicating a spatial element width that is relatively greater than other spatial element widths in the artifact, and a second binary spacing indicator indicating a spatial element width that is relatively less than the other spatial element widths in the artifact; and
the comparison comprises a correlation between:
first character identifiers of the unique copy and first binary spacing indicators of the artifact; and
second character identifiers of the unique copy and second binary spacing indicators of the artifact.

19. The system of claim 15, wherein the comparison of the binary spacing indicators for the artifact with the character identifiers corresponding to the characters of the uniform character code is performed using a Pearson correlation coefficient.

20. The system of claim 15, wherein:
the unique copy is in XML (extensible markup language) or HTML (hypertext markup language) format; and
the artifact is an image.
